(19) United States
(12) Patent Application Publication
(10) Pub. No.: US 2009/0012434 A1
(43) Pub. Date: Jan. 8, 2009

(54) APPARATUS, METHOD, AND SYSTEM TO TREAT A VOLUME OF SKIN

(76) Inventor: Robert S. Anderson, Livermore, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/773,373

(22) Filed: Jul. 3, 2007

(51) Int. Cl. A61H 7/00

(52) U.S. Cl. 601/6

(57) ABSTRACT

Methods, systems, and devices to treat a region of skin; the treatment may be used to stimulate the production of collagen. The region of skin undergoes a series of negative and positive pressures, where the series is characterized by an electronically regulated duty cycle. The region of skin may also be cooled to affect the modulus of elasticity of collagen inside the skin.

### FIELD OF THE INVENTION

The present invention relates to methods, devices, and systems treating skin, and in certain embodiments the invention relates to methods, devices, and systems for stimulating the production of collagen in the skin.

### BACKGROUND

A primary component of the human skin is collagen, which is a fibrous protein that is secreted by fibroblast cells. Collagen exists in an extracellular matrix (ECM) which is part of the dermis of the human skin. There are several types of collagen, of which Type-I and Type-III collagen being predominant in the skin. The ECM is a meshwork of long collagen helical structures, as well as other macromolecules. The ECM attaches to cells using proteins called integrins. Integrins are also responsible for cell signaling.

In aged humans fibroblast cells are less active than in young humans, because the rate of collagen replacement is slower than the rate at which collagen degenerates. Thus portions of the ECM are lost through age which shows as aging skin. External factors also shape ECM. Facial muscles distort the ECM over time creating indentations called wrinkles. Expansion of the skin by pregnancy creates striae, or stretch marks. Nicotine is a known factor in the breakdown of integrin. Fibroblast cells which have their integrin bonds severed from the ECM may generate collagen which is not properly attached to the ECM.

New collagen will be formed by fibroblast cells when an injury occurs to the ECM. Devices have been created to purposely injure the ECM in order to produce new collagen. Examples of which are found in US patent applications US 2005-0251118 A1, US 2006-0189964 A1, and US 2005-0251117 A1. Many of the devices in some part use laser light, ultrasound, and radio frequency energy sources. Heating skin above 65° C. will denature the collagen and cause new growth, but it can also cause pain and burning. The new collagen will also result in a non uniform texture of the skin as is typical of new collagen growth occurring from wounds.

Additionally when a material is stretched beyond its elastic limit, it will break. The relationship between the amount of force required to elastically stretch an object and the increase in length of the object is called the Young's Modulus (E). In the elastic range, E is a constant for some materials, for others E is variable. As the object approaches its elastic limit, its E begins to decrease rapidly implying that an incremental increase in the force applied produces a much larger increasing the length of the object.

For most materials, E is temperature dependent. More importantly, however, is the amount of stretching required before reaching a material's elastic limit is temperature dependent. The lower the temperature, the less stretching is required before reaching the object's elastic limit.

Moreover, when an object is close to or at its elastic limit due to stretching, it is more sensitive to any vibration or other stimulation. More sensitive means the object is more likely to break if it is subject to vibration or other stimulation when it is close to or at its elastic limit.

If an object has been cooled and stretched close to its elastic limit is subjected to rapid temperature rise, it also is more likely to fracture than if it is allowed to increase in temperature slowly, which is called thermal shock.

Many of the devices mentioned above in some part use suction to capture a part of the tissue and apply an energy treatment to the captured tissue. The devices above do not incorporate an electronically regulated method to repetitively treat a volume of skin. Past devices also do not incorporate cooling and heating of tissue in order to effect the E of collagen.

### SUMMARY OF THE DESCRIPTION

Methods, systems, and devices to treat a region of skin are described. According to one aspect of the inventions, and embodiment of a method for treating skin includes sealing a region of skin and drawing it into a device using negative pressure which causes the region of skin to undergo mechanical strain. A subsequent positive pressure causes the region of skin to be pushed out of the device. The region of skin undergoes, in one embodiment, a series of negative and positive pressures, where the series is characterized by an electronically regulated duty cycle. An electronic controller coupled to the device may regulate the duty cycle. Heat may be applied to the region of skin. A DC field may be applied to the region of skin. The application of pressure may be preformed by a device designed to specifically match a specific portion of the human body in order to treat the skin of that portion. A system including a device, pressure regulators, and an electronic controller may be used.

According to one aspect of the invention a portion of tissue is cooled to affect the modulus of elasticity of collagen which resides inside the portion of tissue. The portion of tissue may be stretched before or a after cooling to break the collagen. Energy and rapid heating may be applied to the cooled portion of tissue. The tissue may be additionally stretched or held in a state of constant stretching after cooling until the collagen breaks.

### DESCRIPTION OF THE DRAWINGS

The present invention is illustrated by way of example and not limitation in the figures of the accompanying drawings in which like references indicate similar elements.

FIG. 1 shows a system diagram for the stimulation of collagen.

FIG. 2A shows a chart which illustrates the duty cycle operation of a device used to stimulate the production of collagen.

FIG. 2B shows a chart which illustrates the duty cycle operation of a device used to stimulate the production of collagen.

FIG. 2C shows a chart which illustrates the duty cycle operation of a device used to stimulate the production of collagen.

FIG. 3 shows a cross section of a device used to stimulate the production of collagen on a volume of human skin.

FIGS. 4A and 4B show, in front and side views respectively, a device used to stimulate the production of collagen mounted on a human forehead.

FIGS. 5A and 5B show, in front and side views respectively, a device used to stimulate the production of collagen mounted on a human head adjacent to the eyes.

FIGS. 6A and 6B show, in front and side views respectively, a device used to stimulate the production of collagen mounted on a human head adjacent to the mouth.

FIG. 7 shows a device used to stimulate the production of collagen mounted on a human mid-section.

FIGS. 5A and 8B show a cross section of human tissue in a normal state and being stretched, respectively.

FIG. 9 shows a stress-strain curve in tension, of collagen in a normal state and a cooled state.

FIG. 10 shows a cross section of a hand piece device used to apply suction to, and to cool a portion of tissue.

FIGS. 11A-11C show flow charts for methods to treat a portion of tissue.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a through understanding of various embodiments of the present invention. However, in certain instances, well-known or conventional details are not described in order to provide a concise discussion of embodiments of the present inventions.

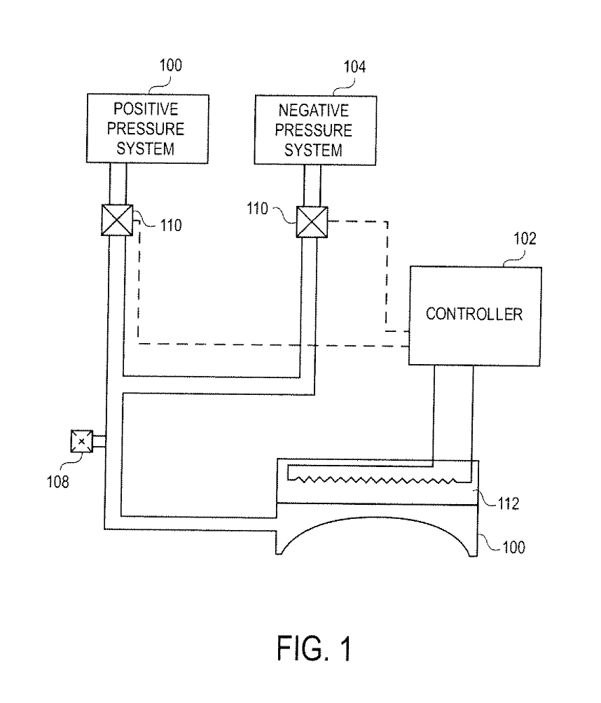

FIG. 1 shows a system for stimulating the production of collagen, according to an embodiment of the invention. The system includes a device 100 which applies positive (e.g. pressures slightly above normal atmospheric or higher pressures) and negative pressure (e.g. pressures below atmospheric pressure such as a partial vacuum) to a portion of skin on a patient, a controller 102, a positive pressure source 104, and a negative pressure source 106. The controller 102 regulates the application of pressure by monitoring a pressure sensor 108 and electronically controlled regulator mechanisms 110 which may be valves. The device forms a sealed internal volume when placed against the skin of a patient.

Placing negative (e.g. a pressure less than atmosphere up to 13 psi or 93 kPa or 700 torr) and positive pressures (e.g. up to 15 psi or 106 kPa or 800 torr) on the skin causes the ECM to stretch and distort, which in turn causes the fibroblast cells to flatten and distort. Mechanical forces on collagen may break collagen which in turn stimulates fibroblasts to generate new collagen. Mechanical forces on fibroblast cells also cause the increased production of epidermal growth factor (EGF) and collagen production, and subsequent attachment of the collagen to the ECM. Mechanical forces also cause the fibroblast cells to migrate along the ECM, causing new growth in different areas of the ECM. For example repetitive pressure treatments at wrinkled, or depressed areas of the skin will cause new growth into the wrinkles areas resulting in a natural, younger appearance.

The device 100 may include a heater 112 controlled by the controller 102. Heating the ECM enhances the growth of new collagen. In general the temperature used would be the temperature the human body experiences while counteracting viruses or infections. The device 100 may include a DC electric field generator (not shown) connected by an electric conduit to the controller 102, and controlled by the controller 102. The DC electric field generator may include electrodes which are positioned in the device 100 so that they are sufficiently close to the skin to apply a DC electric field to the skin when the device 100 forms a seal and a vacuum over the skin. A DC field will cause the integrins to polarize and subsequently fibroblast cells will move in the direction of the DC field causing new collagen growth in different areas of the ECM.

Positive and negative pressures are applied at the device 100 in sequential turns electronically controlled by the controller 102. The positive pressure required is pressure above atmospheric pressure large enough to detect a good seal against the skin while at the same time not forcing the device off the patient, approximately 1-3 psi or 7-21 kPa above atmospheric pressure. The negative pressure required is pressure below atmospheric pressure enough pressure to draw a volume of skin into the device and affect the fibroblast cells and ECM, approximately 3 psi or 20 kPa below atmospheric pressure. A volume of skin may be drawn in the device for as little as a few seconds or less (e.g. 0.05 seconds) to as long as an hour.

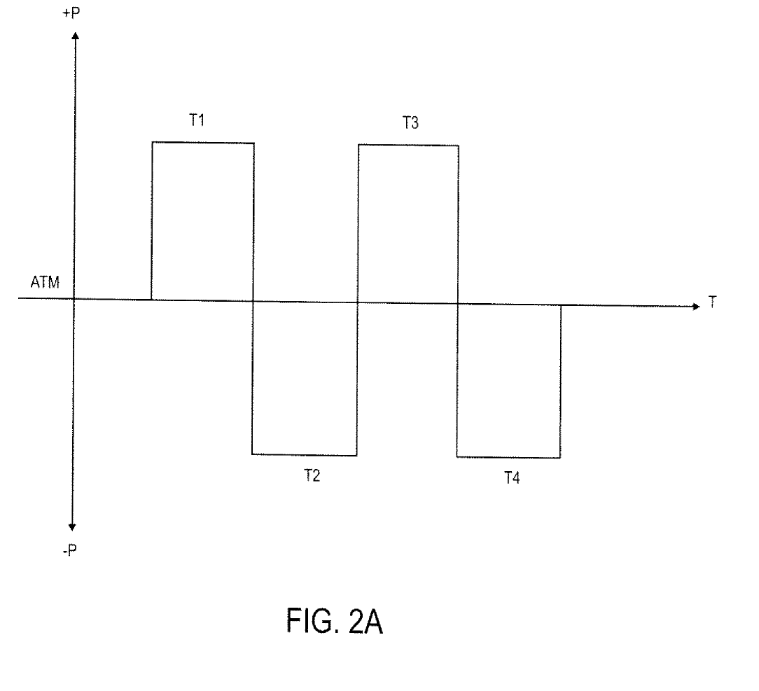

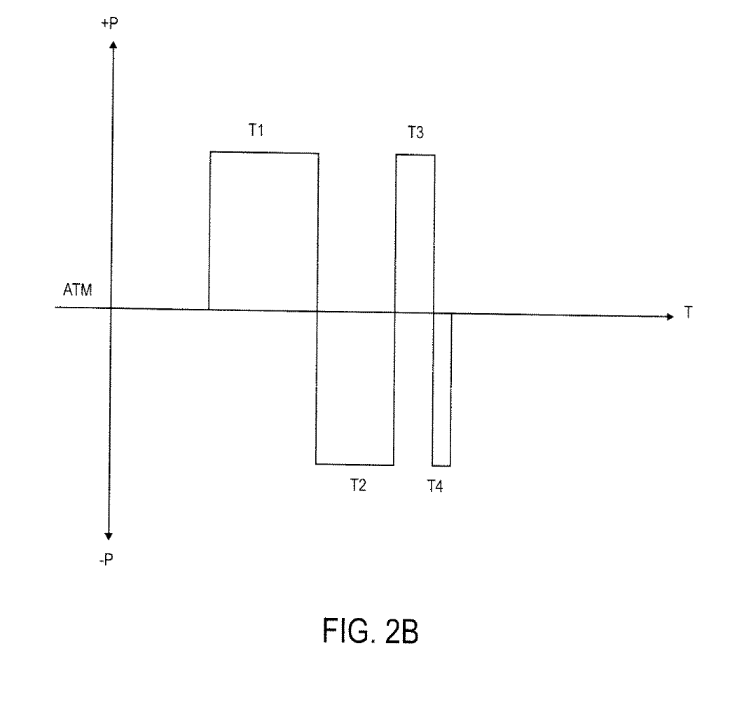

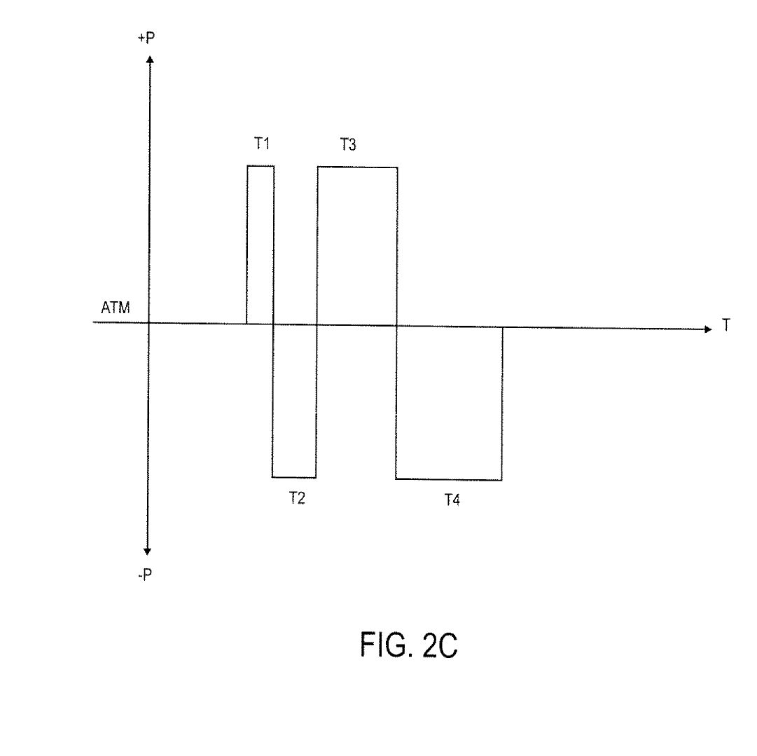

FIG. 2A shows an example of the operation of the device 100 by an electronically regulated duty cycle, controlled by the controller 102. A positive pressure time period T1 and a negative pressure period T2 is shown on a graph of pressure vs. time, with the horizontal time axis being at atmospheric pressure. The ratio of T1 to T2 is called the duty cycle D, or D=T1/T2. The time interval between positive pressure and negative pressure, or pulse, may be as shown as about 0.05 seconds; similarly the time interval between negative and positive pressures may be as short as 0.05 seconds. It has been found that a pulse between 100 and 400 milliseconds provides good results. Shorter pulses (e.g. 200 msec or less) are preferred but such short pulses may not be easily achievable in a technical sense. The time interval between positive pressure time periods and negative pressure time periods may be varied or constant. The duty cycle as shown in FIG. 2A is 1. The duty cycle may be equal to 1, greater than 1, or less than 1, and electronically controlled by the controller. The value of the duty cycle in FIG. 2A remains constant over time, as the duty cycle between T1/T2 and T3/T4 are equal. The value of duty cycles may also increase, decrease, or remain steady over time. FIG. 2A shows no transition slope between pressure peaks, however the operation of the device 100 may have slopes between pressure peaks.

FIG. 2B shows another example of the operation of the device 100 by an electronically regulated duty cycle, controlled by the controller 102. T1 is a larger value than T2, resulting in a duty cycle with a value greater than 1. The value of the duty cycle over time is decreasing as T1/T2 is greater than T3/T4.

FIG. 2C shows another example of the operation of the device 100 by an electronically regulated duty cycle, controlled by the controller 102. T1 is smaller than T2, resulting in a duty cycle with a value less than 1. The value of the duty cycle over time is increasing as T1/T2 is less than T3/T4.

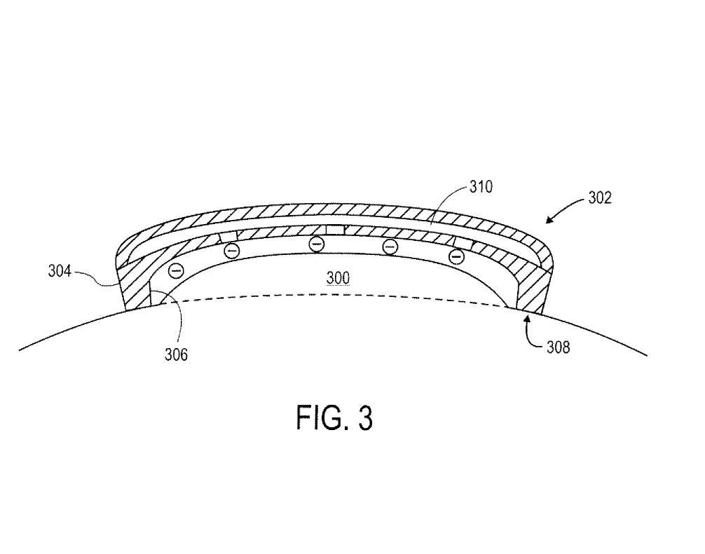

FIG. 3 shows a volume of skin 300 being drawn in to a device 302. The device 302 includes a body with an outer surface 304, an inner surface 306, and a sealing surface 308. Negative pressure causes the volume of skin 300 to be drawn into the inner surface 306. Positive pressure releases the volume of skin 300. The sealing surface 308 may be fully engaged around the volume of skin 300 to ensure negative and positive pressure is maintained. A pressure chamber 310 communicates with the inner surface 306 to provide pressure to the volume of skin 300. The inner surface 306 may be heated to provide heat to the volume of skin 300.

In use a positive pressure is applied to the volume of skin 300 to detect a proper seal at the sealing surface 308, while the device 302 is firmly applied against the skin. For example, air may be injected into the pressure chamber 310 to create a pressure slightly above atmospheric pressure as the device 302 is firmly applied against the skin; a pressure sensor may detect this increased pressure and automatically begin the treatment procedure. When a proper seal is detected the device switches from applying a positive pressure to a negative pressure to draw the volume of skin 300 into the device 302. The volume of skin is both stretched and compressed when drawn into the device 302, which applies forces to the ECM. A sequence of further positive and negative pressures may then be applied to the skin. A final positive pressure may be used to release the volume of skin 300.

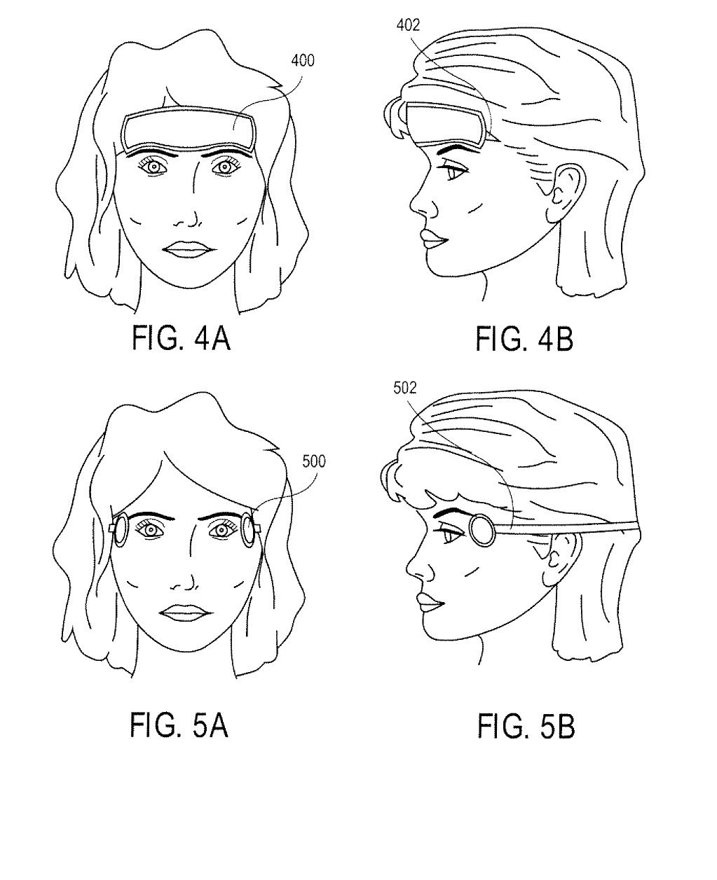

FIGS. 4A and 48 show a device 400 which is contoured to fit against the curvature and shape of a human forehead. Wrinkles develop on human foreheads as a result of years of frowning. Frowning causes the musculature on the forehead to contract forming temporary lines. Frowning combined with loss of collagen causes permanent lines on the forehead to form. The device 400 operates as the devices described above. The device incorporates a head strap 402 which allows greater positive pressures to be applied without ejection of the device 400. Conduits supplying power and pressure to the device 400 may be incorporated into the head strap 402.

FIG. 5A and 5B show a device 500 which is contoured to fit against the curvature and shape of a human head such that pressure devices 502 contact securely in the regions next to the eyes. Wrinkles, or crow's feet as they are commonly known, develop adjacent to the eye region as a result of years of squinting. Squinting causes the musculature adjacent to the eyes to contract forming temporary lines. Squinting combined with loss of collagen causes permanent lines adjacent to the eye region to form. The device 500 operates as the devices described above to cause new growth of collagen in the wrinkled region. The device incorporates a head strap 502 which allows proper positioning and greater positive pressures to be applied without ejection of the device 500. Conduits supplying power and pressure to the device 500 may be incorporated into the head strap 502.

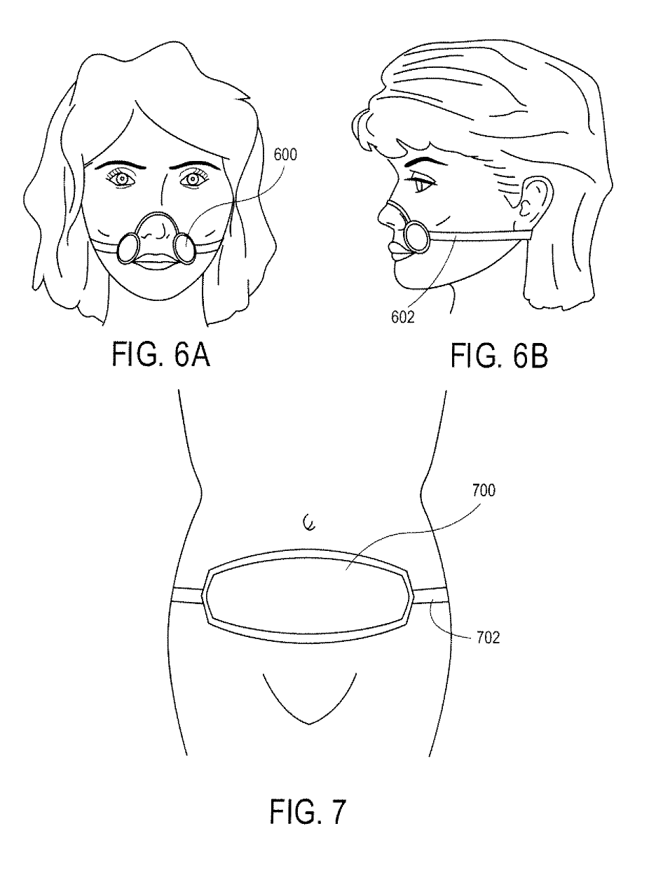

FIGS. 6A and 6B show a device 600 which is contoured to fit against the curvature and shape of a human head such that pressure devices 602 contact securely in the regions next to the mouth. Wrinkles, or “laugh lines” as they are commonly known, develop adjacent to the mouth region as a result of years of smiling. Smiling causes the musculature adjacent to the mouth to contract, forming temporary lines. Smiling combined with loss of collagen causes permanent lines adjacent to the mouth region to form. The device 600 operates as the devices described above to cause new growth of collagen in the wrinkled region. The device incorporates a head strap 602 which allows proper positioning and greater positive pressures to be applied without ejection of the device 600. Conduits supplying power and pressure to the device 600 may be incorporated into the head strap 602.

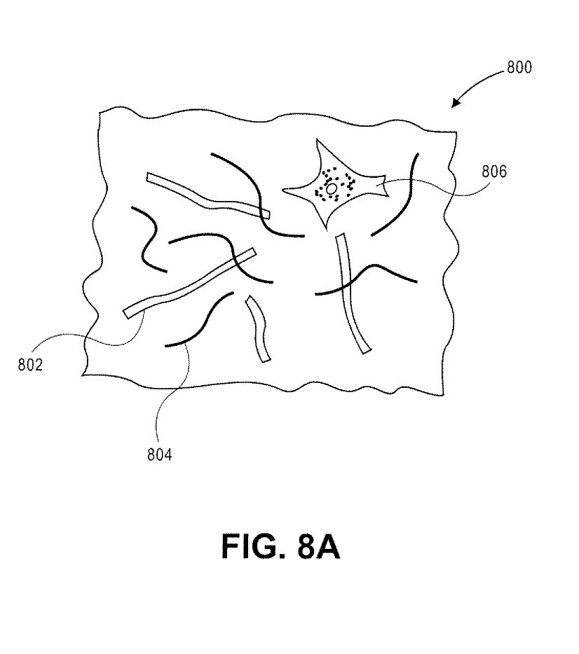

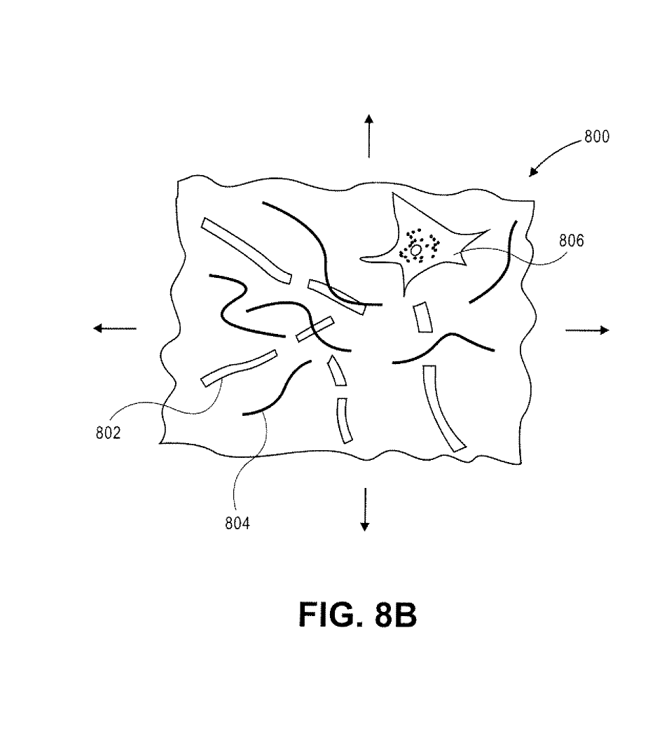

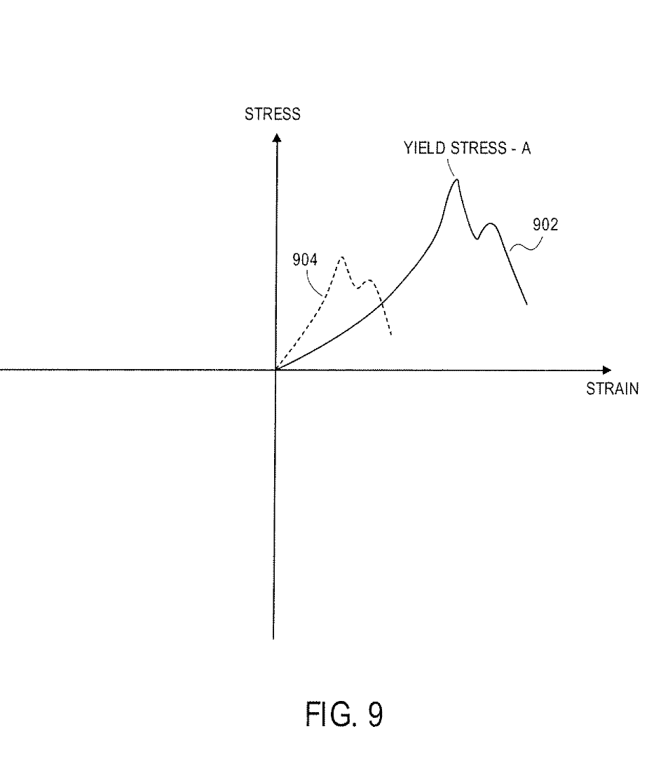

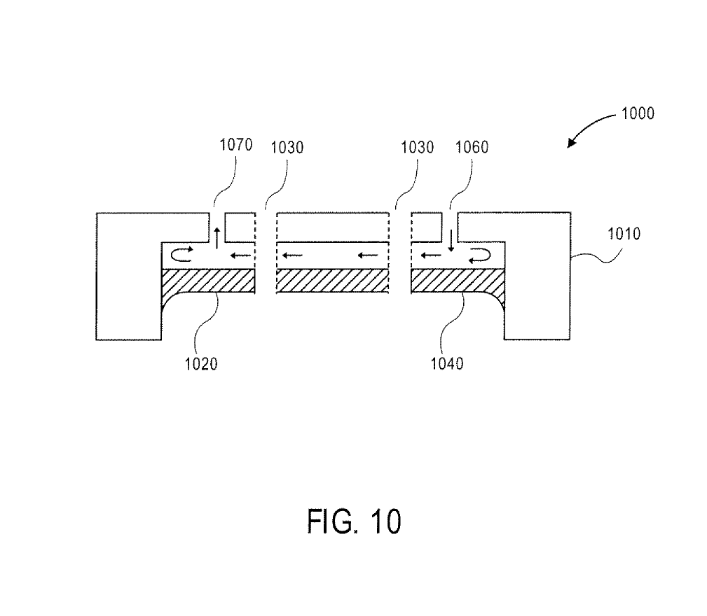

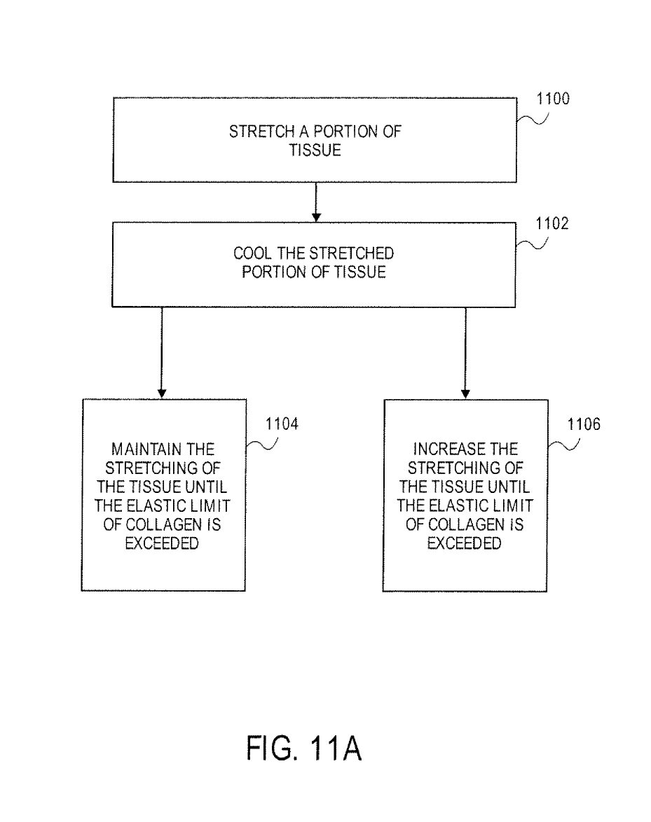

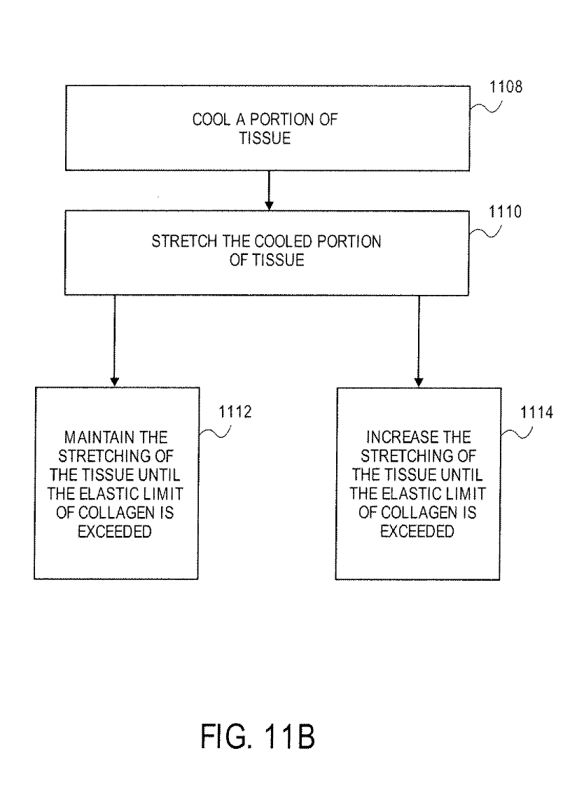

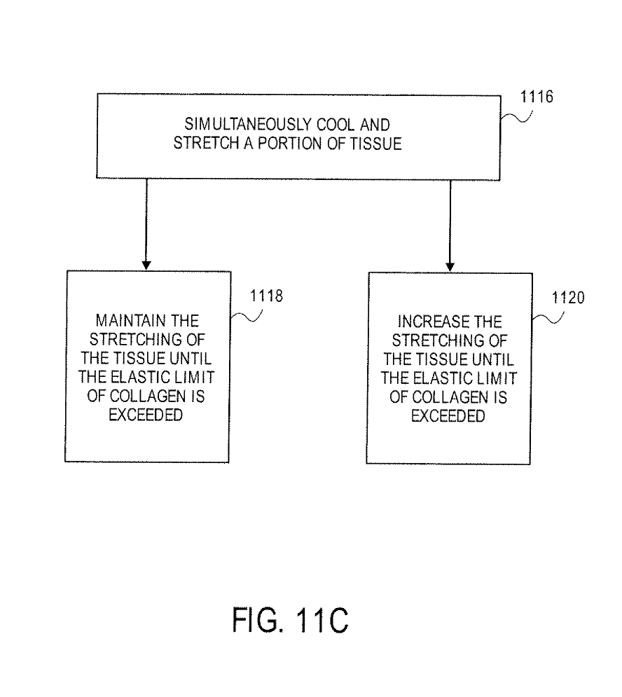

FIG. 7 shows a device 700 contoured to fit a human mid-section, or stomach. Stretch marks often occur in the stomach region as a result of pregnancy. Stretch marks are overstretched regions in the dermis layer of the skin, where tissue has been torn from rapid body growth. The device 700 operates as the devices described above to cause new growth of collagen in the stretch marked region. The device incorporates a strap 702 which allows proper positioning and greater positive pressures to be applied without ejection of the device 700. Conduits supplying power and pressure to the device 700 may be incorporated into the strap 702.

### Cooling and Heating to Affect the Modulus of Elasticity of Tissue

FIG. 8A shows a cross section of human tissue located near the skin. The tissue 800 includes the ECM. The ECM is includes all connective tissue in the body which is non-cellular. The ECM composed primarily of water, proteins and carbohydrates. On the macromolecular level the ECM includes proteins such as collagen 802 and elastin 804. Collagen 802 provides the ECM tensile strength while elastin 804 provides elastic recoil. Also shown fibroblasts 806, a type of cell which creates precursors for maintenance of the ECM. Fibroblasts are responsible for the creation of new collagen.

FIG. 5B shows the cross section as in FIG. 8A being stretched. As shown the tissue 800 is being stretched to such a degree that the collagen 802 breaks. When the collagen 802 breaks the fibroblasts 806 create new collagen 802 which results in more youthful looking skin.

FIG. 9 shows a typical stress-strain diagram for a collagen fiber. Biological tissue does not react to strain as a typical mechanical material would (e.g. does not obey Hooke's law), as a non-linear curve up to the yield point is shown. Curve 902 shows the yield stress of collagen under normal conditions. Stress-Strain curve 902 shows a non-linear tensile curve portion preceding yield point A, and thus the Young's modulus (E) varies up until the yield point. The E of collagen has been experimentally found to range from 2-7 CPa. Curve 904 shows the yield stress of collagen under a cooled condition, as shown the E of collagen and the yield point are altered from the normal condition. Thus under a cooled condition, less strain and stress are required to break a collagen fiber.

The optimum temperature to cool tissue to may be experimentally determined. Individual collagen fibrils have been experimentally tested using X-ray diffraction and atomic force microscopy techniques. These tests may be replicated by testing the samples at temperatures lower than human body temperature (37° C.) until a significant difference in the stress strain curve is achieved. Care should be taken to not use cold temperatures at time intervals long enough to cause tissue death or frostbite. For example, tissue may be exposed to a temperature of 5° C. for 5 seconds to cause the desired effect on collagen.

Cooling may be performed by applying a liquid to the tissue and allowing the liquid to evaporate, thereby chilling the tissue. A liquid (e.g. water, ethyl alcohol, or a combination of the two) is applied to the surface of the tissue, and a subsequent negative pressure is applied to evaporate the liquid and cause a cooling effect on the tissue. Methods, devices, and materials which describe cooling the skin by liquid evaporation are described in commonly assigned U.S. patent application Ser. No. 11/024,340, published as US 2005-0251118A1, which is hereby incorporated by reference in its entirety.

FIG. 10 shows a cross section of a device 1000 which cools the skin through conduction. The device 1000 includes a body 1010 and a cooling plate 1020. Suction ports 1030 function to draw the skin into the device cavity 1040, and into contact with the cooling plate. Alternatively cooled gas may be injected into the suction ports 1030 prior to applying to suction, to cool the skin. The cooling plate 1020 may be constructed from a highly conductive metal such as aluminum or copper. The cooling plate 1020 may be coated with a lubricious coating such as Teflon, to prevent tissue sticking. The cooling plate 1020 is kept cool by a cooling chamber 1050, which includes an inlet port 1060 and an outlet port 1070 to circulate a liquid (e.g. chilled water, low pressure liquid refrigerant). Additionally energy such as laser light, ultrasound, radio frequency energy, and heat may be applied to tissue through elements not shown and described in this disclosure. The application of suction and energy may also be pulsed as described in this disclosure.

FIG. 11A shows a flow chart for a method for treating a portion of tissue with devices described herein. At module 1100 tissue is initially stretched, which may be performed mechanically or through suction or pressure. At module 1102 the stretched tissue is cooled which changes the mechanical properties of collagen within the tissue, which allows less required stretching to fracture the collagen fibers. The method may then proceed to module 1104 or 1106. In module 1104 the stretching of the tissue is maintained from module 1100 until the elastic limit of the collagen is exceeded. Alternatively in module 1106 the stretching of the tissue is increased until the elastic limit of the collagen is exceeded. Additionally the tissue may be exposed to sonic or ultrasonic vibration after or during cooling. The collagen will be more sensitive to vibration. Additionally the tissue may be rapidly heated after it has been cooled to induce thermal shock, and thus making the collagen more likely to fracture.

FIG. 11B shows a flow chart for a method for treating a portion of tissue with devices described herein. At module 1108 tissue is initially cooled which changes the mechanical properties of collagen within the tissue, which allows less required stretching to fracture the collagen fibers. At module 1110 the cooled tissue is stretched, which may be performed mechanically or through suction or pressure. The method may then proceed to module 1112 or 1114. In module 1112 the stretching of the tissue is maintained from module 1110 until the elastic limit of the collagen is exceeded. Alternatively in module 1114 the stretching of the tissue is increased until the elastic limit of the collagen is exceeded. Additionally the tissue may be heated or subjected to vibration as described above.

FIG. 11C shows a flow chart shows a flow chart for a method treating a portion of tissue with devices described herein. In module 1116 a portion of tissue is simultaneously cooled and stretched. The method the proceeds to module 1118 or 1120. In module 1118 the stretching of the tissue is maintained from module 1116 until the elastic limit of the collagen is exceeded. Alternatively in module 1120 the stretching of the tissue is increased until the elastic limit of the collagen is exceeded. Additionally the tissue may be heated or subjected to vibration as described above.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method to stimulate the production of collagen, comprising
applying a series of alternating positive and negative air pressures to a sealed region of skin with a device, wherein the series is characterized by an electronically regulated duty cycle designed to stimulate the production of collagen.

2. The method of claim 1 wherein the series operates under a duty cycle with a value of 1, or less than 1, or greater than 1.

3. The method of claim 1 wherein the duty cycle varies over time.

4. The method of claim 1 additionally comprising heating the sealed region of skin.

5. The method of claim 1 wherein the positive and negative air pressures are characterized by time periods which vary over the series.

6. A medical device to stimulate the production of collagen on a human forehead, comprising:
a elongated body with an outer surface and an inner surface defining a cavity, and a sealing surface surrounding the cavity and between the outer and inner surfaces, wherein the body is profiled to fit against the forehead and wherein when the sealing surface is fitted against the forehead a positive and negative pressure may be applied in the cavity onto the forehead; and
a strap coupled to the elongated body.

7. The device of claim 6 wherein the body includes a heat source coupled to the inner surface.

8. The device of claim 6 wherein the strap includes at least one fluid conduit.

9. The device of claim 6 wherein the strap includes at least one electrical conduit.

10. A medical device to reduce the appearance of crow's feet on the human face, comprising:
at least one body with an outer surface and an inner surface defining a cavity, and a sealing surface surrounding the cavity and between the outer and inner surfaces, wherein the body is profiled to fit against a portion of a skin adjacent to an eye, and wherein when the sealing surface is fitted against the portion of skin positive and negative pressure may be applied onto the portion of skin; and
a strap coupled to at least one body.

11. The device of claim 10 wherein the body includes a heat source coupled to the inner surface.

12. The device of claim 10 wherein the strap includes at least one fluid conduit.

13. The device of claim 10 wherein the strap includes at least one electrical conduit.

14. A medical device to reduce the appearance of laugh lines on the human face, comprising:
at least one body with an outer surface and an inner surface defining a cavity, and a sealing surface surrounding the cavity and between the outer and inner surfaces, wherein the body is profiled to fit against a portion of a skin adjacent to a mouth, and wherein when the sealing surface is fitted against the portion of skin positive and negative pressure may be applied onto the portion of skin; and
a strap coupled to at least one body.

15. The device of claim 14 wherein the body includes a heat source coupled to the inner surface.

16. The device of claim 14 wherein the strap includes at least one fluid conduit.

17. The device of claim 14 wherein the strap includes at least one electrical conduit.

18. A medical device to reduce the appearance of stretch marks on a human mid-section, comprising:
a elongated body with an outer surface and an inner surface defining a cavity, and a sealing surface surrounding the cavity and between the outer and inner surfaces, wherein the body is profiled to fit against the mid-section and wherein when the sealing surface is fitted against the mid-section a positive and negative pressure may be applied in the cavity onto the mid-section; and
a strap coupled to the elongated body.

19. The device of claim 18 wherein the body includes a heat source coupled to the inner surface.

20. The device of claim 18 wherein the strap includes at least one fluid conduit.

21. The device of claim 18 wherein the strap includes at least one electrical conduit.

22. A medical treatment system to stimulate the production of collagen, comprising:
a device designed to apply a skin positive and negative pressure onto a portion of skin;
a positive pressure source regulator;
a negative pressure source regulator; and
an electronic controller which couples to the body and provides a duty cycle for applying positive and negative pressure to the portion of skin in order to stimulate the production of collagen.

23. The system of claim 22 wherein the electronic controller provides energy for a heat source coupled to the device.

24. A method to stimulate the production of collagen, comprising:
stretching a portion of human tissue, wherein collagen inside the human tissue has an first elastic limit; and
cooling the stretched portion of human tissues wherein the first elastic limit changes to a second elastic limit.

25. The method of claim 24 additionally comprising additionally stretching the cooled and stretched portion of human tissue beyond the second elastic limit.

26. The method of claim 24 additionally comprising maintaining the stretching of the cooled and stretched portion of human tissue beyond the second elastic limit.

27. The method of claim 24 additionally comprising applying an energy source to the cooled and stretched portion of human tissue to cause a rapid temperature rise.

28. The method of claim 27 wherein the energy source is one or more of a group including electrical energy, visible radiation, infrared radiation, or laser energy.

29. The method of claim 24 wherein cooling is accomplished by contacting the stretched portion of human tissue with a cold surface.

30. The method of claim 24 wherein cooling is accomplished by evaporation of a material from the stretched portion of human tissue.

31. The method of claim 24 wherein cooling is accomplished by contacting the stretched portion of human tissue with a chilled gas.

32. The method of claim 24 additionally comprising applying a vibration energy source to the cooled and stretched portion of human tissue.

33. The method of claim 32 wherein the vibration energy is sonic or ultrasonic energy.

34. The method of claim 24 additionally comprising rapidly heating the cooled portion of tissue to induce thermal shock.

35. A method to stimulate the production of collagen, comprising:
cooling a portion of human tissue, wherein collagen inside the human tissue has an first elastic limit; and
stretching the cooled portion of human tissue, wherein the first elastic limit changes to a second elastic limit.

36. The method of claim 35 additionally comprising additionally stretching the cooled and stretched portion of human tissue beyond the second elastic limit.

37. The method of claim 35 additionally comprising maintaining the stretching of the cooled and stretched portion of human tissue beyond the second elastic limit.

38. The method of claim 35 additionally comprising applying an energy source to the cooled and stretched portion of human tissue to cause a rapid temperature rise.

39. The method of claim 38 wherein the energy source is one or more of a group including electrical energy, visible radiation, infrared radiation, or laser energy.

40. The method of claim 35 wherein cooling is accomplished by contacting the stretched portion of human tissue with a cold surface.

41. The method of claim 35 wherein cooling is accomplished by evaporation of a material from the stretched portion of human tissue.

42. The method of claim 35 wherein cooling is accomplished by contacting the stretched portion of human tissue with a chilled gas.

43. The method of claim 35 additionally comprising applying a vibration energy source to the cooled and stretched portion of human tissue.

44. The method of claim 43 wherein the vibration energy is sonic or ultrasonic energy.

45. The method of claim 35 additionally comprising rapidly heating the cooled portion of tissue to induce thermal shock.

46. A device for stimulating the production of collagen, the device comprising:
a body having a cavity configured to be placed over human tissue;
a conduit in the body, the conduit configured to receive at least one of a negative pressure, to develop a partial vacuum in the cavity, and a positive pressure, to develop the positive pressure in the cavity;
a cooling element coupled to the body the cooling element configured to cool a portion of the human tissue while it is stretched to stimulate the production of collagen.

47. The device as in claim 46 wherein the partial vacuum in the cavity stretches the human tissue while the cooling element cools the portion of the human tissue.
